(19) United States
(12) Patent Application Publication
(10) Pub. No.: US 2010/0014162 A1
(43) Pub. Date: Jan. 21, 2010

(54) Single or Dual-Sided Adhesive Tape for Protecting Electrochrome Layer Systems on Mirrors

(75) Inventors: Bernd Bunde, Apensen (DE); Axel Burmeister, Buchholz (DE); Sabine Thornmeier, Buchholz (DE); Peter Himmelsbach, Buxtehude (DE)

Correspondence Address: Mark D. Marin;Norris McLaughlin & Marcus, PA, 875 Third Avenue, 18th Floor, New York, NY, 10022, US

(73) Assignee: tesa AG, Hamburg (DE)

(21) Appl. No.: 11/721,877

(22) PCT Filed: Dec. 21, 2005
(86) PCT No.: PCT/EP05/57059

§ 371 Date: Jul. 10, 2007

(30) Foreign Application Priority Data
Dec. 21, 2004 (DE) 10 2004 062 770.3

(51) Int. Cl. G02B 23/16

(52) U.S. Cl. 359/513

(57) ABSTRACT

An adhesive tape for protecting electrochromic layer systems on mirrors, having a multilayer carrier consisting of at least one top and one bottom film part, each formed by at least one polymeric film, and also at least one metallic part, which is located between the top and bottom film parts and is formed from a metallic layer of, in particular, aluminum, the exposed side of the bottom film part carrying an adhesive.

The invention describes an adhesive tape for protecting electrochromic layer systems on mirrors, having a multilayer carrier with a barrier effect toward oxygen and water vapor, and also toward other harmful gases, and also having an adhesive which does not affect the function of the electrochromic layer system of a mirror and yet forms a firm bond with the mirror.

In the course of night-time driving the driver of a vehicle is continually dazzled by following vehicles, via the rearview mirrors installed in the vehicle.

This dazzling is not only annoying but also contains a large potential for hazard, since the concentration of the vehicle driver is disrupted and, in particular, since the dazzling leaves the driver unable properly to perceive and assess the traffic in front of him or her.

In the case of interior vehicle mirrors, this problem has to date been solved through the use of prismatic mirrors which can be adjusted mechanically from a day position into a night position. This manual adjustment of the respective mirror position inevitably diverts the driver's attention and harbors the risk, furthermore, of inadvertent misadjustment of the mirror.

In the case of exterior mirrors, moreover, the use of prismatic mirrors is not an option.

Accordingly, a way was sought to dim interior and exterior mirrors automatically.

Mirrors known in this context include, firstly, liquid-crystal mirrors and, secondly, electrochromic mirrors.

DE 35 26 973 A1 describes a dazzle-free liquid-crystal mirror for use as an interior mirror in vehicles. According to that patent the following construction is realized on a support substrate:
transparent electrode made for example of indium-tin oxide (ITO)
silicon nitride layer
polyimide alignment layer
liquid crystals
polyimide alignment layer
silicon nitride layer
aluminum layer as reflector and electrode; and to finish
support substrate.

The patent proposes a variety of types of glass as support substrate.

When an electrical field is applied between the two electrodes, the mirror dims. Liquid-crystal mirrors, though, possess a number of disadvantages. For instance, they harbor the risk of double images and the emergence of the liquid crystals in the event of damage. Additionally, as a result of the use of two glass plates to encapsulate the above layer construction, the proposed constructions are very heavy and of very deep construction.

DE 37 84 536 A1 proposes electrochromic dimming as a solution to the problem, through the use of electrochromic solid-state materials. Electrochromism describes the changes in the optical properties of molecules (for example, the optical absorption) as a result of a local electrical field which is external or is present in the system. Electrochromism is based on the effect of electrical fields on electronic states. Electrochromism encompasses the use of layers of electrochromic material, which darkens in response to an applied voltage. Existing electrochromic materials remain dimmed in response to an initial voltage input. They lighten again in response to a neutralizing voltage. The extent of the lightening or dimming is directly dependent on the voltage applied.

The following exemplary construction is disclosed for the mirror:
glass plate
transparent electrode of, for example, indium-tin oxide (ITO)
electrochromic layer (1) of nickel hydroxide
insulating layer with tantalum pentoxide
electrochromic layer (2) of tungsten oxide
conducting reflector layer such as aluminum

DE 199 08 737 A1 teaches that, for the long-term stability of an electrochromic element, it is vital for the electrochromic layer construction both to protect against gases present in the environment and to prevent the immigration of volatile constituents from the electrochromic layer construction. One way, accordingly, would be to encapsulate the electrochromic layers by means of two glass substrates.

The necessary encapsulation of the layer system is presumed also to be the reason why only electrochromic mirror systems protected with two glass plates have been able to establish themselves within the market.

Given that vehicle mirrors must in some cases be biradially curved, encapsulation by means of two glass plates, which must both have the same radius of curvature, is extremely difficult to realize from a technical standpoint. A further problem is filling the encapsulation by the two glass plates without harmful air bubbles. The solution to this problem is found to be extremely complicated, and is described for example in EP 0 613 039 A1.

Therefore, as well as the disadvantages already mentioned, of high weight and of great depth of construction, encapsulation has further disadvantages in the context of its use in the vehicle mirror sector.

DE 299 17 320 U disclosed an adhesive tape which is impervious to diffusion, has a high tear propagation resistance, and meets the requirements of fire prevention. This is achieved by the carrier material consisting of a composite aluminum-polyester material. In this composite, the aluminum foil sets a water vapor diffusion barrier, and the polyester film guarantees improved tear propagation resistance, allowing the adhesive tape to be bonded under tensile strain.

Furthermore, aluminized polyester films treated adhesively on one side are prior art. Tapes of this kind are used, for example, to bond the ends, or for the continuous bonding, of plastic-coated wall coverings.

U.S. Pat. No. 6,413,645 A describes a construction which includes a barrier layer, the barrier layer being composed in particular of metal oxides or metal nitrides. Aluminum layers which are applied by vapor deposition and produce a barrier effect with respect to air or water vapor are widespread in particular in the packaging sector. Mention may be made, by way of example, of DE 196 23 751 A.

The object on which the invention is based is that of providing an adhesive tape which affords an easy-to-process, lightweight, and relatively thin protection for substantially two-dimensional functional layers such as electrochromic layers, electroluminescent layers and/or OLEDs (organic light-emitting devices; organic polymers as luminescent layers for cellphone and camera displays), particularly for the mirrors known from DE 37 84 536 A1.

This object is achieved by means of an adhesive tape as specified in the main claim. The dependent claims provide advantageous developments of the adhesive tape and also preferred fields of application of the adhesive tape of the invention.

The invention lies accordingly in an adhesive tape for protecting electrochromic layer systems on mirrors, having a multilayer carrier consisting of at least one top and one bottom film part, each formed by at least one polymeric film, and also at least one metallic part, which is located between the top and bottom film parts and is formed from a metallic layer of, in particular, aluminum, the exposed side of the bottom film part carrying an adhesive.

The metallic layer in the adhesive tape of the invention serves as a barrier layer, in other words keeping corrosion-promoting substances such as water, water vapor, oxygen, sulfur dioxide, and carbon dioxide away from the material to be protected (in particular the substantially two-dimensional functional layers).

The permeability of the metallic layer is restricted in particular to the following values:
permeability of O₂<0.1 g/m²/24 h, in particular <0.01 g/m²/24 h, especially <0.005 g/m²/24 h
(measured at 23° C. and 50% relative humidity)
permeability of H₂O<0.1 g/m²/24 h, in particular <0.01 g/m²/24 h, especially <0.005 g/m²/24 h
(measured at 37.8° C. and 90% relative humidity)

In a first advantageous embodiment of the invention the metallic layer has a thickness of 10 nm to 50 μm, in particular 18 to 25 μm.

The application of the metallic layer to the film part is accomplished by means for example of vapor deposition: that is, by the production on the polymeric film of a coating by means of thermal evaporation under vacuum (electrically with electron beams, by cathode sputtering or wire explosion, where appropriate with assistance from laser beams). The metallic layer in that case preferably has a thickness of 10 nm to 30 nm. The metallic layer may also be composed of a rolled metal foil. In that case the metallic layer preferably has a thickness of 5 μm to 30 μm.

Metals that can be selected include silver, copper, gold, platinum, aluminum and aluminum compounds, tin, Nichrome, NIROSTA, titanium, and metal oxides such as cadmium oxides, tin oxides, zinc oxides, and magnesium oxides. This enumeration should not be considered to be exhaustive; instead, the skilled worker is able to select further metal layers, not explicitly specified here, without departing from the concept of the invention.

Advantageous embodiments of the adhesive tape are constructed as follows.

The top film part is a polymeric film of polyester, the metallic layer is an aluminum layer and/or the bottom film part is a polymeric film of polyolefins, preferably polypropylene, or polyester.

The top film part is a polymeric film of polyolefins, preferably polypropylene, the metallic layer is an aluminum layer and/or the bottom film part is a polymeric film of polyester.

With further preference the polyester film is provided with the metallic layer by virtue of said layer having been applied by vapor deposition to said film.

With further preference the film parts are each formed by a laminate of polymeric films, preferably a laminate of a polyester film and of a polyolefin film.

The polymeric films are adhesively bonded using binders (laminating resins) such as epoxy resins, melamine resins, thermoplastics, etc.

Preference is given to polyester films 10 μm to 40 μm thick and to polyolefin films 20 μm to 120 μm thick.

In addition it is also possible to employ three-layer or multilayer laminates, without departing from the concept of the invention.

In one particularly preferred embodiment the two film parts are each composed of a laminate of a polyester film and of a polyolefin film, preferably polypropylene film, and are disposed such that the carrier has a symmetrical construction around the preferred aluminum foil core.

The symmetrical construction provides for increased thermal stability. At the same time a distinct improvement is obtained in the flat lie of the adhesive tape in use.

In addition, the top film part may bear further layers, selected from the group consisting of polymeric films, including metallized polymeric films, and metal foils.

By way of example mention may be made of further constructions of the carrier that have proven advantageous.
bottom film part polyester film
top film part polypropylene film
metallic layer aluminum layer carried on the polyester film of the bottom film part the top film part carrying the following additional layers in the stated order:
polypropylene film
polyester film with applied aluminum layer, the aluminum layer being disposed in such a way that it lies against the polypropylene film.
bottom film part laminate of a polypropylene film and a polyester film, the laminate being disposed such that the adhesive is carried on the polypropylene film
top film part polyester film
metallic layer aluminum layer carried on the polyester film of the bottom film part, the top film part carrying the following additional layers in the stated order:
second aluminum layer, carried on the polyester film of the top film part, second polypropylene film, the second aluminum layer being disposed in such a way that it lies against the second polypropylene film.

As polymeric film it is preferred to use polyesters and polypropylene. In addition, outstanding properties are also displayed by films composed, for example, of PU, PP, PE, PVC, PVDC, PEN, PAN, EVOH and PA, PA with nanocomposites.

PA with nanocomposites comprises a PA filled with phyllosilicate. These particles have a platelet-shaped structure similar to that of talc. In contrast to talc, the particle size is considerably smaller (nanometer range). These particles are oriented in the course of extrusion and form a layer structure. The particles themselves, like glass, are completely impermeable to gases. The gases are hindered from penetrating the film; this is the basis for the improved barrier effect. The layer structure forms a kind of labyrinth through which the gases and aromas have to pass. Because of the small particle size, there is no adverse effect on the optical properties of the film.

Films 10 μm to 160 μm thick are preferred for the polymeric film(s).

The advantage of polyester is that a polyester film has good barrier properties. Moreover the film ensures temperature stability on the part of the adhesive tape, and in addition an increased mechanical stability.

In a further advantageous embodiment of the invention the adhesive tape is provided on both sides with an adhesive, so that a further adhesive is present on the film part as well.

The adhesive is based preferably on acrylate polymers, on acrylate block copolymer coated from solution, on an acrylate dispersion or on polyethylene-vinyl acetate polymers. With further preference the adhesive is a self-adhesive composition.

Acrylate dispersions are known and are used in large quantities not only for adhesives of adhesive tapes but also for adhesives of labels. The acrylate dispersions comprise acrylate polymer particles in disperse distribution in the aqueous phase of the dispersion.

Acrylate dispersions are typically prepared in an aqueous medium by polymerization of appropriate monomers. Their preparation may take place either by means of a batch operation or by metered addition of one or more components during the polymerization. In the case of batch operation, all of the components required are introduced simultaneously as an initial charge.

The properties of the acrylate dispersions and of the corresponding adhesives are determined predominantly by the selection of the monomers and by the molecular weight obtained. The principal monomers are n-butyl acrylate, 2-ethylhexyl acrylate, and acrylic acid. Suitable monomer units are described in “Acrylic Adhesives”, Donatas Satas, in Handbook of Pressure Sensitive Adhesive Technology, Second Edition, edited by Donatas Satas, Van Nostrand Reinhold New York, pp. 396-456.

Acrylate dispersions used contain in particular [% by weight in each case]
0 to 10% acrylic acid units
0 to 100% n-butyl acrylate units
0 to 100% 2-ethylhexyl acrylate units.

One preferred version uses acrylate dispersions with 0.5% to 3% acrylic acid units. Another preferred version uses acrylate dispersions with 0.5% to 3% acrylic acid units and 99.5% to 90%, more preferably 99.5% to 96%, n-butyl acrylate units. A further example of acrylate dispersions of the invention are acrylate dispersions with 80% to 90% 2-ethyl-hexyl acrylate units and 8% to 20% n-butyl acrylate units.

The acrylate dispersions may additionally comprise further monomer units, through which is it possible, for example, to control the glass transition temperature and the crosslinkability. Examples are methyl acrylate, ethyl acrylate, methylethyl acrylate, maleic anhydride, acrylamide, glycidyl methacrylate, isopropyl acrylate, n-propyl acrylate, isobutyl acrylate, n-octyl acrylate, and the methacrylates corresponding to these acrylates. The acrylate dispersions typically contain 0% to 10% of these additional monomer units; either exclusively one additional monomer unit is used, or mixtures of such units are used.

The glass transition temperature obtained depends on the monomers employed. In the dried state, the acrylate dispersions used for the adhesives of the invention have glass transition temperatures in particular of between 80° C. and −15° C., preferably between −75° C. and −25° C., and with particular preference between −55° C. and −35° C.

The solids content of the acrylate dispersions is in particular between 30% and 70% by weight, preferably 45% and 60% by weight.

Examples that may be mentioned are the acrylate dispersions Primal PS 83d and Primal PS 90 from Rohm & Haas.

Additional monomers suitable for the use of nonadhesive acrylate dispersions are preferably copolymerized as optionally additional monomers together with the esters of acrylic and/or methacrylic acid. Examples are acrylamide, glycidyl methacrylate, hydroxyethyl methacrylate, dimethylaminoethyl methacrylate, vinyl acetate, styrene, and maleic anhydride. EP 0 375 215 B1 from ICI describes such dispersions for example. If desired, the dispersion may comprise further additions, such as, for example, fillers, or crosslinking agents. Suitable crosslinking agents may be epoxy resins, amine derivatives such as, for example, hexamethoxymethylmelamine and/or condensation products of an amine, melamine for example, urea with an aldehyde, formaldehyde for example. In order to obtain nonadhesive polyacrylate dispersions it has been found favorable to add, where appropriate, further compounds which react, for example, with the carboxyl groups of the polymer. Examples of such are aziridines, such as ethyleneimine and propyleneimine.

The adhesives used to produce the adhesive tapes may comprise further components. Examples are resins, plasticizers, dyes, defoamers, and thickeners, and also further adjuvants for setting the desired rheological characteristics. Modifications of acrylate dispersions are known and are described for example in “Modification of Acrylic Dispersions”, Alexander Zettl, in Handbook of Pressure Sensitive Adhesive Technology, Second Edition, edited by Donatas Satas, Van Nostrand Reinhold New York, pp. 457-493.

Aqueous resin dispersions, i.e., dispersions of resin in water, are known. Preparation and properties are described for example in “Resin Dispersions”, Anne Z. Casey, in Handbook of Pressure Sensitive Adhesive Technology, Second Edition, edited by Donatas Satas, Van Nostrand Reinhold New York, pp. 545-566.

Resin dispersions of hydrocarbon resins and modified hydrocarbon resins are likewise known and are offered for example by Hercules BV under the trade name Tacolyn (Example: Tacolyn 4177).

Suitable dispersions are resin dispersions based on hydrocarbon resins or on modified hydrocarbon resins having a softening point of between 50° C. and 100° C. The adhesive may contain, for example, 5% to 28% by weight of the resin dispersions. The solids content of the resin dispersions is typically between 40% and 70%.

The adhesive may be admixed with resin dispersions based on mixtures of different hydrocarbon resins, and also on mixtures of hydrocarbon resins with other known resins. Possible examples include mixtures of hydrocarbon resins with small amounts of resins based on rosin or modified rosin or phenolic resins, other natural resins, resin esters or resin acids.

The adhesive may further be admixed with plasticizing components such as plasticizer resins, liquid resins, oils or other known components such as, for example, alkoxylated alkylphenols. Alkoxylated alkylphenols are known and are described in, for example, U.S. Pat. No. 4,277,387 A and EP 0 006 571 A. The use of alkoxylated alkylphenols as plasticizers has been proposed in, among other places, “Modification of Acrylic Dispersions”, Alexander Zettl, in Handbook of Pressure Sensitive Adhesive Technology, Second Edition, edited by Donatas Satas, Van Nostrand Reinhold New York, p. 471.

The properties of the alkoxylated alkylphenols are determined by the alkyl radical and predominantly by the construction of the polyglycol ether chain. In the course of the preparation it is possible to use both ethylene oxide and propylene oxide. One particular version uses propoxylated alkylphenol. Water-insoluble alkoxylated alkylphenols are preferred. Further preference is given to alkoxylated alkylphenols having a boiling point greater than 100° C., preferably greater than 130° C., and with particular preference greater than 200° C.

Using crosslinkers, the adhesive can be optimized for higher shear strength. The selection and proportion of the crosslinkers are known to the skilled worker. Crosslinkers for acrylate dispersions are known in principle and described in, for example, “Acrylic Adhesives”, Donatas Satas, in Handbook of Pressure Sensitive Adhesive Technology, Second Edition, edited by Donatas Satas, Van Nostrand Reinhold New York, pp. 411 to 419.

Isocyanate-based crosslinkers are known in principle, but are not preferred, on account of the limited pot lives and the increased workplace safety cost. An example of an isocyanate-based crosslinker is Basonat F DS 3425X (BASF).

Isocyanate-free crosslinkers are preferred, examples being crosslinkers based on salts of polyfunctional metals. These crosslinkers are known in principle and are described for example in U.S. Pat. No. 3,740,366 A, U.S. Pat. No. 3,900,610 A, U.S. Pat. No. 3,770,780 A, and U.S. Pat. No. 3,790,553 A. Particularly suitable are crosslinkers based on zinc complexes, which are able to form covalent and/or complex-type bonds with carboxyl groups.

Another adhesive which has proven suitable is one based on acrylate hotmelt that has a K value of at least 20, in particular greater than 30, and is obtainable by concentrating a solution of such a composition, to give a system which can be processed as a hotmelt. The concentration may take place in appropriately equipped tanks or extruders; particularly in the case of concomitant degassing, a degassing extruder is preferred.

An adhesive of this kind is set out in DE 43 13 008 A1, the content of which is hereby incorporated by reference to become part of the content of the present disclosure and invention. In an intermediate step, the solvent is removed completely from the acrylate compositions prepared in this way.

At the same time, in addition, other volatile constituents are removed. After coating from the melt, these compositions contain only small remaining fractions of volatiles. Accordingly it is possible to adopt all of the formulas/monomers claimed in the above-cited patent. A further advantage of the compositions described is seen as being the fact that they have a high K value and hence a high molecular weight. The skilled worker is aware that systems with relatively high molecular weights can be crosslinked with greater efficiency. Accordingly there is a drop in the proportion of volatile constituents.

The solution of the composition may contain 5% to 80% by weight, in particular 30% to 70% by weight, of solvent.

It is preferred to use commercially customary solvents, particularly low-boiling hydro-carbons, ketones, alcohols and/or esters.

With further preference use is made of single-screw, twin-screw or multiscrew extruders having one or, in particular, two or more degassing units.

The adhesive based on acrylate hotmelt may have had benzoin derivatives incorporated into it by copolymerization, as for example benzoin acrylate or benzoin methacrylate, acrylic esters or methacrylic esters. Benzoin derivatives of this kind are described in EP 0 578 151 A1.

Alternatively, the acrylate hotmelt-based adhesive may be chemically crosslinked.

One particularly preferred embodiment uses, as self-adhesive compositions, copolymers of (meth)acrylic acid and the esters thereof with 1 to 25 C atoms, maleic, fumaric and/or itaconic acid and/or their esters, substituted (meth)acrylamides, maleic anhydride, and other vinyl compounds, such as vinyl esters, especially vinyl acetate, vinyl alcohols and/or vinyl ethers.

The residual solvent content ought to be below 1% by weight.

An adhesive which has been found particularly suitable is a low molecular mass, pressure-sensitive, acrylate hotmelt adhesive, of the kind carried by BASF under the name acResin UV or Acronal®, especially Acronal® DS 3458. This adhesive, with a low K value, acquires its application-compatible properties as a result of a final, radiation-induced crosslinking procedure.

In a further embodiment of the invention the adhesive is based on polyethylene-vinyl acetate (EVA) with a vinyl acetate fraction of 40% to 90% by weight and with an ISO 1133 (A/4) melt index MFI of 0.5 to 25 g/10 min at 190° C. and 2.16 kg.

Since the polymer framework in question is chemically uncrosslinked, and on the basis of its monomer ratio is only slightly crystalline or not crystalline at all, the molecular weight, which correlates directly with the MFI, adopts a decisive position in respect of the cohesiveness of the adhesive. An MFI of 1 to 5 g/10 min at 190° C. and 2.16 kg has proven to be a favorable figure. The addition of an EVA portion with an MFI of up to 25, however, may contribute to improving the flow properties if the adhesive is applied from the melt.

A radiation crosslinking procedure following application of the adhesive, effected in particular by means of electron beam curing, is a possibility for raising the cohesion and for preventing contraction-induced residues.

In order to obtain supplementary desired properties it is possible for the adhesive to be blended with one or more additives such as tackifier resins, plasticizers, aging inhibitors or fillers.

Examples of tackifier resins for increasing the adhesive properties of the adhesive are hydrocarbon resins (composed, for example, of unsaturated C₅ or C₇ monomers), terpene-phenolic resins, terpene resins made from raw materials such as α-pinene or β-pinene, aromatic resins such as coumarone-indene resins or resins of styrene or α-methylstyrene, but preferably rosin and its derivatives such as disproportionated, dimerized or esterified resins, where glycols, glycerol or pentaerythritol can be used for the esterification, and also others as listed in Ullmann's Enzyklopädie der technischen Chemie, Volume 12, pages 525 to 555 (4th edition), Weinheim. Particularly suitable are resins stable to aging without an olefinic double bond, such as hydrogenated resins, for example.

Examples of plasticizers, whose use is optional, include aliphatic, cycloaliphatic, and aromatic mineral oils, diesters or polyesters of phthalic acid, trimellitic acid or adipic acid, polyethers, and also liquid rubbers (for example, nitrile rubbers or polyisoprene rubbers), liquid polymers of butene and/or isobutene, acrylic esters, polyvinyl ethers, liquid resins and plasticizer resins based on the raw materials for tackifier resins, lanolin and other waxes, or liquid silicones.

In order to make the adhesive even more stable to the effects of UV it is possible to add light stabilizers. Their function consists primarily in the prevention of the decomposition of the adhesive. Of particular suitability for the adhesive of the invention are HALS light stabilizers such as, for example, dimethyl succinate polymer with 4-hydroxy-2,2,6,6-tetramethyl-1-piperidineethanol (CAS No. 65447-77-0), bis(2,2,6,6-tetramethyl-4-piperidinyl)sebacate (CAS No. 52829-07-9) or poly[[6-[(1,1,3,3-tetramethyl butyl)amino]-1,3,5-triazine-2,4-diyl][[(2,2,6,6-tetramethyl-4-piperidyl)imino]hexamethylene[(2,2,6,6-tetramethyl-4-piperidyl)imino]] (CAS No. 70624-18-9).

Suitable fillers and pigments are, for example, carbon black, titanium dioxide, calcium carbonate, zinc carbonate, zinc oxide, silicates or silica.

Preference is being given to a pressure-sensitive adhesive based on one or more block copolymers, with further preference at least one block copolymer being composed, at least in part, on the basis of (meth)acrylic acid derivatives, the at least one block copolymer comprising at least the unit P(A)-P(B)-P(A), comprising at least one polymer block P(B) and at least two polymer blocks P(A), where
P(A) independently of one another represent homopolymer or copolymer blocks made up at least to 75% by weight of monomers of group A, the (co)polymer blocks P(A) each having a softening temperature in the range from 0° C. to +175° C.,
P(B) represents a homopolymer or copolymer block made up of monomers of group B, the (co)polymer block P(B) having a softening temperature in the range from −130° C. to +10° C., and
the (co)polymer blocks P(A) and P(B) are not homogeneously miscible with one another at 25° C.

It is further of advantage if the block copolymer or copolymers are present to at least 50% by weight in the pressure-sensitive adhesive.

Pressure-sensitive adhesives (PSAs) which have proven advantageous are those for which the structure of the block copolymer/block copolymers can be described by one or more of the following general formulae:

P(A)-P(B)-P(A) (I)

P(B)-P(A)-P(B)-P(A)-P(B) (II)

[P(A)-P(B)]ₙX (III)

[P(A)-P(B)]ₙX[P(A)]ₘ (IV),

where n=3 to 12, m=3 to 12, and X is a polyfunctional branching unit, i.e., a chemical structural element via which different polymer arms are linked to one another, where, further, the polymer blocks P(A) independently of one another represent homopolymer or copolymer blocks made up to at least 75% by weight of monomers of group A, the polymer blocks P(A) each having a softening temperature in the range from 0° C. to +175° C., and where the polymer blocks P(B) independently of one another represent homopolymer or copolymer blocks made up of monomers of group B, the polymer blocks P(B) each having a softening temperature in the range from −130° C. to +10° C.

The polymer blocks P(A) may be polymer chains of a single variety of monomer from group A, or may be copolymers of monomers of different structures from group A; where appropriate they can be copolymers of at least 75% by weight of monomers of group A and up to 25% by weight of monomers of group B. The monomers used from group A may vary in particular in their chemical structure and/or in the side chain length. The polymer blocks therefore cover the range between fully homogeneous polymers, via polymers formed from monomers of the same chemical parent structure but differing in chain length, and polymers with the same number of carbons but differing in isomerism, through to randomly polymerized blocks of monomers of different length with different isomerism from group A. The same is true of the polymer blocks P(B) in respect of the monomers from group B.

For the purposes of this specification the term “polymer blocks” is therefore intended to include not only homopolymer blocks but also copolymer blocks, unless specified otherwise in a particular case.

The unit P(A)-P(B)-P(A) may be either symmetrical [corresponding to P1(A)-P(B)-P2(A) with P1(A)=P2(A)] or asymmetrical [corresponding for instance to the formula P3(A)-P(B)-P4(A) where P3(A)≠P4(A), but where both P3(A) and P4(A) are each polymer blocks as defined for P(A)] in construction.

An advantageous configuration is one in which the block copolymers have a symmetrical construction such that polymer blocks P(A) identical in chain length and/or chemical structure are present, and/or such that polymer blocks P(B) identical in chain length and/or chemical structure are present.

P3(A) and P4(A) may differ in particular in their chemical composition and/or their chain length.

Suitable monomers of group A contain a C═C double bond, in particular one or more vinyl groups in the true sense and/or vinylic groups. Vinylic groups referred to here are groups wherein some or all of the hydrogen atoms of the unsaturated C atoms are substituted by organic and/or inorganic radicals. In this case, acrylic acid, methacrylic acid and/or derivatives thereof are also included among the compounds containing vinylic groups. Above compounds are referred to collectively below as vinyl compounds.

Advantageous examples of compounds used as monomers of group A are vinylaromatics. Specific monomers, whose recitation is only by way of example, however, include styrene, α-methylstyrene, o-methylstyrene, o-methoxystyrene, p-methoxystyrene or 4-methoxy-2-methylstyrene, for example.

As monomers of group A it is additionally possible with advantage to use acrylates, such as acrylate-terminated polystyrene or α-bromophenyl acrylate, for example, and/or methacrylates, such as methacrylate-terminated polystyrene (for example, Methacromer PS 12 from Polymer Chemistry Innovations), 1,2-diphenylethyl methacrylate, diphenylmethyl methacrylate, o-chlorobenzyl methacrylate, p-bromophenyl methacrylate, and/or acrylamides, such as N-benzylmethacrylamide, for example.

The monomers can also be used in mixtures with one another. Specific examples of such comonomers, without any claim being made to completeness, are o-cresyl methacrylate, phenyl methacrylate, benzyl methacrylate or o-methoxyphenyl methacrylate.

Additionally, however, the polymer blocks P(A) may also be constructed as copolymers such that they consist to an extent of at least 75% of the above monomers of group A or of a mixture of these monomers, leading to a high softening temperature, but may also contain, at up to 25%, monomers of group B, leading to a lowering of the softening temperature of the polymer block P(A). In this context mention may be made, by way of example, of alkyl acrylates, which are defined in accordance with the structure B1 and the comments made in relation thereto.

Monomers of group B for the elastomer block P(B) are advantageously likewise chosen such that they contain C═C double bonds (especially vinyl groups and vinylic groups). As monomers of group B it is advantageous to use acrylate monomers. For this purpose it is possible in principle to use all of the acrylate compounds which are familiar to the skilled worker and are suitable for synthesizing polymers. It is preferred to choose those monomers which, alone or in combination with one or more further monomers, result in glass transition temperatures of less than +10° C. for the polymer block P(B). Correspondingly it is possible with preference to choose vinyl monomers.

For the preparation of the polymer blocks P(B) it is advantageous to use 75% to 100% by weight of acrylic and/or methacrylic acid derivatives of the general structure

CH₂═CH(R1)(COOR2) (B1)

where R1=H or CH3 and R2=H or linear, branched or cyclic, saturated or unsaturated hydrocarbon chains having 1 to 30, in particular having 4 to 18, carbon atoms,
and up to 25% by weight of monomers (B2) from the vinyl compounds group, these monomers B2 favorably containing functional groups.

The weight percentages above add up preferably to 100%, although the total may also amount to less than 100% if other (polymerizable) monomers are present.

Acrylic monomers of group B which are used in the sense of compound B1 as components for polymer blocks P(B) include acrylic and methacrylic esters with alkyl, alkenyl and/or alkynyl groups consisting of 4 to 18 C atoms. Specific examples of such compounds, without wishing to be restricted by this recitation, include n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, and also cyclic monomers such as cyclohexyl or norbornyl acrylate and isobornyl acrylate, for example.

In addition it is possible, optionally, to use vinyl monomers from the following groups as monomers B2 for polymer blocks P(B): vinyl esters, vinyl ethers, vinyl halides, vinylidene halides, and also vinyl compounds containing aromatic rings and heterocycles in a position. Here again, mention may be made, by way of example, of selected monomers which can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile.

As particularly preferred examples of monomers containing vinyl groups, in the sense of B2, for the elastomer block P(B), suitability is additionally possessed by hydroxyethyl acrylate, hydroxypropyl acrylate, hydroxyethyl methacrylate, hydroxypropyl methacrylate, n-methylolacrylamide, acrylic acid, methacrylic acid, allyl alcohol, maleic anhydride, itaconic anhydride, itaconic acid, benzoin acrylate, acrylated benzophenone, acrylamide, and glycidyl methacrylate, to name but a few.

All monomers which can be employed may likewise be used in a halogenated form.

In further advantageous embodiments of the PSA it comprises a blend of
at least one diblock copolymer with at least one triblock copolymer, or
at least one diblock copolymer with at least one star-shaped block copolymer,
at least one triblock copolymer with at least one star-shaped block copolymer, preferably at least one of the aforementioned components, and advantageously all of the block copolymer components of the blend, constituting block copolymers in the sense of the above definition.

One advantage of the adhesive is that, during the bonding procedure, it allows air located between adhesive and object to emerge. In this way, air inclusions are almost completely prevented. Furthermore, there are few gaps or defects formed through which, again, air or water vapor might enter and so migrate within or beneath the adhesive to the electrochromic layer.

In a further advantageous embodiment the adhesive tape is not transparent and offers the substrate to be protected protection from radiation, particularly UV radiation.

There are a variety of ways in which the adhesive tape of the invention can be produced.

On the one hand it can be produced by coating with the carrier from a solution of the adhesive or by coating from the melt, the latter operation taking place possibly by extrusion or by calendering.

As a third way, the adhesive can be applied to the carrier by a transfer method. In that case the adhesive is first applied, from solution or as a melt, to an intermediate carrier and then joined by means of a laminating step to the carrier material with barrier effect.

The adhesive can be applied in one step but advantageously can also be applied in two or more steps. Thus the layers of adhesive that are applied in different steps may exert different functions, by virtue of being differently additized.

For instance, the base application on the carrier may be provided with a light-absorbing pigment, carbon black for example, and so may protect the adhesive applied in further steps from direct radiation. Optionally it is also possible for the finishing layer, which has contact with the substrate, to be blended with tackifier resins, while the base layer is not additized or is otherwise additized. The examples given above do not constitute a restriction, but instead merely stand as representatives of all of the conceivable combinations which are within the concept of the invention.

The adhesive tape can either be produced in the form of a roll, i.e., rolled up on itself in the form of an Archimedean spiral, or else lined on the adhesive side with release materials such as siliconized paper or siliconized film. The latter is especially appropriate for producing adhesive diecuts shaped in accordance with the intended application.

The adhesives used do not affect the function of the individual layers. They are very largely free from migrating substances, particularly those which hinder the transport of ions between the individual layers. Particular mention may be made here of monovalent and divalent metal ions, acids and alkalis, and also all migrating, discoloring substances which can accumulate between the layer system.

For the purpose of secure adhesive bonding, the adhesive on the metallic layer and also, where appropriate, on the film layer has a layer thickness of 10 μm to 200 μm, in particular from 20 μm to 100 μm, with particular advantage from 40 μm to 80 μm.

The adhesive can be coated directly from the solution, by means of a coating bar. In this case the solvent used is evaporated subsequently in a commercially customary drying tunnel. Solventless coating by means of a nozzle or roll coating unit is also appropriate. For particularly sensitive layers, so-called indirect coating is advisable with both coating technologies. In this case the adhesive to be coated is not coated directly onto the respective layer, but is instead first coated onto a release film or release paper and subsequently joined to the actual carrier by means of roll lamination.

The adhesives may further be lined with liner papers or liner films.

Particular advantage attaches to the use of the adhesive tape of the invention for protecting substantially two-dimensional functional layers such as electrochromic layers, electroluminescent layers and/or OLEDs (organic light-emitting devices, organic polymers as luminescent layers for cellphone and camera displays), in particular for protecting electrochromic layer systems on mirrors.

Specifically in the case of mirror manufacture there are imposing requirements made on the composite materials of the mirrors. These requirements are set out in GDS 10.000.001-00. In addition there are various statutes that need to be taken into account. One quality which deserves emphasis is that of suitability as a safety covering for the mirror glass, which is tested by means of a falling-ball test. Further key points are the stress test and storage test under different loads, such as different climatic zones, aggressive climate, temperatures and atmospheric humidity, and exposure to UV stabilizers. All of the requirements are met by the adhesive tape of the invention.

In addition it can also be used to outstanding effect to protect displays, (flexible) solar cells, and electroluminescent lamps.

As a double-sided adhesive tape it serves not only for protection but also for the simultaneous fixing of articles.

The adhesive tape of the invention can be offered as a continuous roll, wound in the form of an Archimedean spiral around—usually—a cardboard or plastic core, and offered as a diecut label. The latter may have any desired form, adapted outstandingly to the particular end use.

The FIGURE described below is used to illustrate the invention in more detail, without therefore wishing to subject it to any unnecessary restriction.

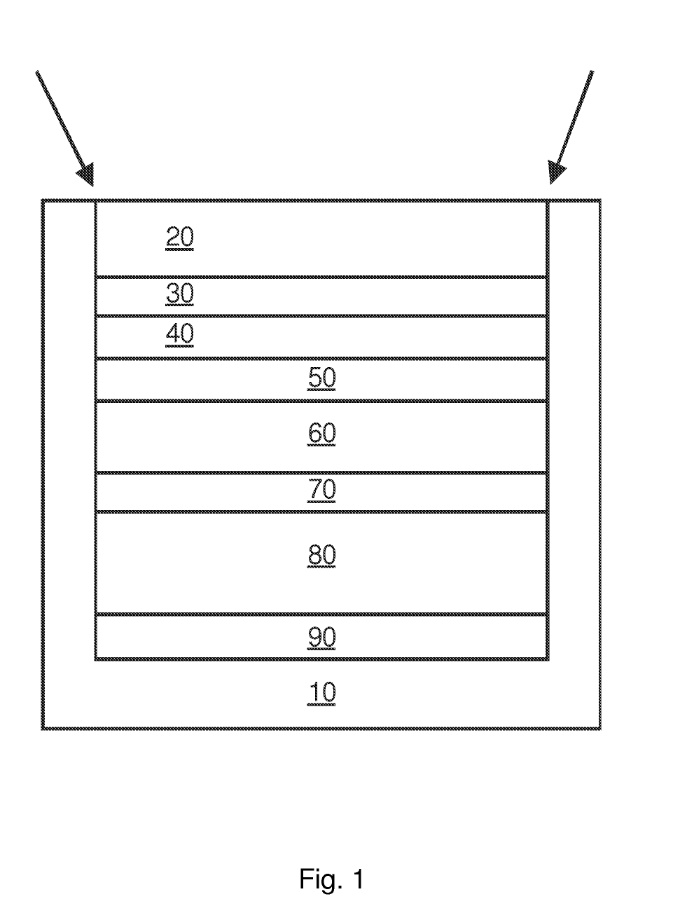

FIG. 1 shows the adhesive tape in lateral section, as bonded adhesively in a mirror housing.

FIG. 1 shows how the adhesive tape of the invention is bonded in a mirror housing 10. The first three layers, 20, 30, and 40, form part of the mirror, beginning with the glass layer, to which the electrochromic layer 30 is applied, and is covered by an aluminum layer 40.

The electrochromic layer 30 is composed of the following layers, not shown in detail:
transparent electrode of, for example, indium-tin oxide (ITO)
electrochromic layer (1) of nickel hydroxide
insulating layer of tantalum pentoxide
electrochromic layer (2) of tungsten oxide

Serving for protection of the electrochromic layer 30 is the adhesive tape of the invention, which has the following construction:

The purpose of the adhesive 50 is to fix the adhesive tape to the aluminum layer 40. The carrier itself is composed of a bottom film part 60 (polymeric film of polyester), a metallic layer 70 of aluminum, and a top film part 80 (polymeric film of polypropylene).

In order to fix the adhesive tape in turn securely in the mirror housing 10, the upper film part 80 carries a second adhesive 90, which assures the bond to the mirror housing 10.

The arrows indicate the places at which air and/or water vapor penetrate between glass 20 and mirror housing 10. If the electrochromic layer 30 were not to be protected by means of the adhesive tape of the invention against attacks thereon, there would, sooner or later, be failure of the electrochromic layer.

The intention of the text below is to describe the invention in more detail with reference to an example, without therefore wishing to subject the invention to any unnecessary restriction.

### EXAMPLE

A self-adhesive composition composed of a polyethylene-vinyl acetate resin mixture, consisting of 66 parts by weight of polyethylene-vinyl acetate with a vinyl acetate content of 45 mol % and a melt index of 15 to 35 g/10 min (190° C./2.2 N in accordance with ISO 1133) and 33 parts by weight of a tackifier resin of the glycerol ester of hydrogenated rosin type, with a softening range of 80° C. to 110° C., is dissolved at 40% strength by weight in toluene, and in a coating unit with coating bar and drying tunnel is applied at 250 μm to an assembly 600 mm wide.

The assembly is composed of a polyester film 23 μm thick, atop which there is an 82 μm polypropylene film containing 1% by weight TiO₂, which carries an aluminum foil 20 μm thick.

The drying temperature is 80° C. with a residence time of 3 minutes.

After drying, the layer thickness of the applied adhesive is 50 μm.

The material is lined on the adhesive side with a siliconized release film 36 μm thick, and is wound to form a jumbo roll.

| | | |
|---|---|---|
| Product thickness | μm | 211 |
| Bond strength to glass, instantaneous | N/cm | >3 |
| Bond strength to glass, 5 min 80° C. | N/cm | >4.5 |
| Water vapor imperviousness | g/m²/24 h | <0.03 |

An imperviousness with respect to water vapor of between 0.03 g/m²/24 h shows the outstanding barrier effect of the adhesive tape of the invention with respect to water vapor.

Adhesives which can be used in accordance with the invention can likewise be produced without solvent, and additionally can be produced using an extruder or a roller.

Additionally, the acrylate dispersions Primal DS 83 from Rohm & Haas, and Acronal in hotmelt form from BASF, can be employed and have shown good results.

1. An adhesive tape for protecting electrochromic layer systems on mirrors, said adhesive tape comprising a multilayer carrier and an adhesive, said multilayer carrier comprising of at least one top and one bottom film part, each formed by at least one polymeric film, and also at least one metallic part, which is located between the top and bottom film parts and formed from a metallic layer, and wherein the adhesive is located on an exposed side of the bottom film part.

2. The adhesive tape of claim 1, wherein the top film part is a polymeric film of polyester, the metallic layer is an aluminum layer and/or the bottom film part is a polymeric film of polyolefins.

3. The adhesive tape of claim 1, wherein the top film part is a polymeric film of polyolefins, the metallic layer is an aluminum layer and/or the bottom film part is a polymeric film of polyester.

4. The adhesive tape of claim 1, wherein the film parts are each formed from a laminate of polymeric films.

5. The adhesive tape of claim 4, wherein the two film parts are each composed of a laminate of a polyester film and of a polyolefin film, and are disposed such that the carrier has a symmetrical construction around the metallic layer.

6. The adhesive tape of claim 1 wherein, the metallic layer is a metal foil or has been applied by vapor deposition as a layer to a film part or to a polymeric film.

7. The adhesive tape of claim 1 wherein the top film part bears further layers selected from the group consisting of polymeric films, metallized polymeric films, and metal foils.

8. The adhesive tape of claim 1 wherein carrier has the following construction:
bottom film part polyester film, top film part polypropylene film, metallic layer aluminum layer carried on the polyester film of the bottom film part, the top film part carrying the following additional layers in the stated order: polypropylene film, polyester film with applied aluminum layer, the aluminum layer being disposed in such a way that it lies against the polypropylene film.

9. The adhesive tape of claim 1 wherein the carrier has the following construction:
bottom film part laminate of a polypropylene film and a polyester film, the laminate being disposed such that the adhesive is carried on the polypropylene film, top film part polyester film, metallic layer aluminum layer carried on the polyester film of the bottom film part, the top film part carrying the following additional layers in the stated order: second aluminum layer, carried on the polyester film of the top film part, second polypropylene film, the second aluminum layer being disposed in such a way that it lies against the second polypropylene film.

10. The adhesive tape of claim 1 wherein the adhesive tape is not transparent.

11. The adhesive tape of claim 1 wherein the outermost top ply of the carrier carries a second adhesive or a double sided adhesive tape.

12. The adhesive tape of claim 1 wherein the adhesive is based on acrylate polymers, acrylate block copolymer coated from solution, an acrylate dispersion or polyethylene-vinyl acetate polymers.

13. A method for protecting substantially two-dimensional functional layers, said method comprising applying the adhesive tape of claim 1 to said layer.

14. A method for protecting displays, (flexible) solar cells, and electroluminescent lamps comprising applying an adhesive tape of claim 1 to said display, solar cell or electroluminescent lamp.

15. A method for simultaneously fixing articles comprising applying an adhesive tape of claim 1 to said articles.

16. The adhesive tape of claim 2 wherein the bottom film part is a polymeric film of polypropylene or polyester.

17. The adhesive tape of claim 3 wherein the top film part is a polymeric film of polypropylene.

18. The adhesive tape of claim 4 wherein the top and bottom film parts are each formed from a laminate of polyester film and polyolefin film.

19. The adhesive tape of claim 18 wherein the top and bottom film parts are each form from a laminate of polyester film and polypropylene film.
